(19) United States
(12) Patent Application Publication
(10) Pub. No.: US 2026/0010956 A1
(43) Pub. Date: Jan. 8, 2026

(54) REAL-TIME CERTIFICATION AND LIFECYCLE AUTOMATION OF ENVIRONMENTAL CREDITS

(71) Applicant: Olha Sytnyk, Lima (PE)

(72) Inventor: Olha Sytnyk, Lima (PE)

(21) Appl. No.: 19/260,425

(22) Filed: Jul. 4, 2025

(51) Int. Cl. G06Q 40/04; G06Q 20/38; G06Q 30/018

(52) U.S. Cl. CPC G06Q 40/055; G06Q 20/3825; G06Q 20/389; G06Q 30/018

(57) ABSTRACT

A system for real-time certification and lifecycle automation of environmental credits. The system comprises: (i) a physical data collection layer equipped with on-land sensors, aerial LiDAR, satellite imagery, environmental DNA (eDNA) sampling, and community-contributed field data; (ii) an Ecological Oracle Engine, which uses an AI protocol to validate, classify, and interpret multi-source ecological data, supported by an adaptive reference library; and (iii) a smart contract protocol deployed on a blockchain network, configured to autonomously convert verified ecological data into financial instruments by issuing, pricing, transferring, freezing, and retiring tokenized environmental credits. The system performs continuous verification of each credit and includes freezing functionality based on ecological performance. It supports multiple credit types, including but not limited to carbon, biodiversity, and water credits. The system may be integrated with external modules for integrates with a Digital Twin of Nature and Web3 ecosystems, including decentralized marketplaces, ReFi platforms, and DAO mechanisms.

### GLOSSARY OF TERMS

Environmental Credits: A quantified and verified digital or registrable unit representing a measurable ecological service or outcome, such as carbon sequestration, biodiversity preservation, or water retention, generated by a specific land area, conservation action, or ecosystem process. Each credit reflects a standardized amount of ecological impact (e. g., one metric ton of CO₂ equivalent or defined biodiversity value) and may be issued, tracked, traded, or retired in accordance with market rules, protocols, or smart contract logic. Environmental credits may be issued individually or as bundled instruments covering multiple services.

Ex-Post Credit: An environmental credit issued after a measurable ecological outcome (e. g., carbon sequestration, biodiversity restoration, water retention) has been achieved and verified through direct, field-collected data. Ex-post credits are based on real-time or near-real-time validation of actual performance and are certified only after ecological impact occurs. This patent is focused on ex-post credit issuance and lifecycle automation through AI and blockchain infrastructure.

Ex-Ante Credit: A forecast-based environmental credit issued in advance of ecological impact, based on predictive modeling of expected outcomes (e. g., projected biomass growth or restoration success). Ex-ante credits typically rely on digital twin simulations, historical baselines, and statistical confidence scoring, with issuance subject to vesting, conditional validation, or future performance monitoring. These mechanisms are covered in a separate patent focused on ex-ante protocols.

Lifecycle Automation: An end-to-end process managed by smart contracts that governs the full life of an environmental credit, from creation and validation through transfer, bundling, repricing, expiration, and retirement, without manual input.

Ecological Oracle Engine: A real-time data collection, processing, and forecasting system. It uses a combination of artificial intelligence, ecological sensors (e. g., satellite, drone, eDNA, IoT), blockchain, and scientific models to deliver reliable, verifiable insights about ecosystems, biodiversity, carbon cycles, and other natural capital.

Real-Time: The capability of a system to process, analyze, and act upon incoming data immediately or with minimal delay, enabling dynamic responses such as live credit issuance, freezing, pricing, or execution. Refers to the system's ability to ingest, process, and respond to environmental data with minimal delay. Real-time in this context means that credit issuance or freezing actions are based on current, continuously streaming data from field sensors—not periodic reviews or retrospective reports.

Certification of Environmental Credits: The process of confirming the authenticity, accuracy, and eligibility of ecological performance to issue and validate environmental credits. Certification includes: (a) Determining credit eligibility based on ecological data (b) Verifying compliance with credit standards or methodologies (c) Issuing and registering credits on a ledger or registry

Validation of Environmental Credits: a continuous or periodic verification step that ensures the underlying ecological asset is performing as originally certified. Validation uses incoming data to assess whether the credit remains eligible for trading or retirement and may trigger freezing or revocation if conditions are no longer met.

Smart Contract: a self-executing software program deployed on a blockchain that automatically performs predefined actions—such as credit issuance, pricing adjustment, freezing, transfer, or retirement—based on input data and embedded logic.

Freeze Functionality: A risk control feature embedded in smart contracts that automatically suspends the validity or tradability of an environmental credit if ecological performance thresholds (e.g., NDVI drop, species loss) are breached.

Tokenized Credit: A cryptographically secure, blockchain-recorded digital representation of an environmental credit, enabling transparent issuance, trading, validation, and retirement with immutable tracking.

Adaptive Reference Library: A dynamically evolving database used by AI engines to identify species, benchmark ecological states, classify land types, and compare environmental performance. It is updated automatically through feedback loops and includes visual, acoustic, genomic, and field-verified ecological data.

Feedback Learning Loop: an iterative data refinement process in which verified field observations, model outputs, or anomalies are re-integrated into the AI system to enhance future classification accuracy, prediction quality, and adaptive behavior of the oracle system.

Digital Twin of Nature: A high-fidelity, dynamic replica of a real-world forest or ecosystem, continuously synchronized with multi-source ecological data. It simulates ecosystem health, land-use change, and credit performance under various scenarios to support predictive modeling and decision-making.

REDD+ (Reducing Emissions from Deforestation and Forest Degradation Plus): An internationally recognized climate change mitigation mechanism under the United Nations Framework Convention on Climate Change (UNFCCC), REDD+ refers to policy approaches and positive incentives for reducing greenhouse gas emissions from deforestation and forest degradation, as well as the conservation, sustainable management of forests, and enhancement of forest carbon stocks in developing countries.

Artificial Intelligence (AI): As used in this specification and claims, “artificial intelligence” refers to any computational technique or system capable of performing tasks that typically require human intelligence. This includes, but is not limited to: Machine learning models (e.g., supervised, unsupervised, or reinforcement learning), Deep learning architectures (e.g., convolutional neural networks, transformers, or recurrent neural networks), Rule-based systems, decision trees, or logic-based inference engines, Probabilistic reasoning models, such as Bayesian networks, Evolutionary algorithms, including genetic algorithms or swarm intelligence, Natural language processing (NLP) systems or symbolic AI, Any combination or hybrid thereof. For purposes of this application, the term AI also encompasses statistical classifiers, heuristics, and any adaptive algorithmic model capable of data classification, pattern recognition, decision-making, anomaly detection, or prediction, whether executed locally, remotely, or via distributed computing infrastructure.

### APPLICATION FIELD

The present invention relates to the technical field of environmental credit certification and lifecycle management systems, specifically those applicable to carbon, biodiversity, water, and other ecosystem service credits. More particularly, the invention concerns a real-time, outcome-based (ex-post) system for the autonomous issuance, continuous validation, and full-cycle management of environmental credits. The system includes modules for data-driven issuance, verification, registration, monitoring, pricing, transfer, bundling, freezing, and retirement—each governed by blockchain-based smart contracts. The invention is applicable to REDD+ and related conservation mechanisms, including carbon sequestration, biodiversity preservation, and water quality management projects across diverse natural ecosystems such as forests, grasslands, protected reserves, rivers, wetlands, lakes, oceans, seas, and glaciers.

For scope clarity, this patent application covers exclusively ex-post credit certification protocols—wherein credits are issued based on ecological performance data that has already occurred and has been validated in real time using on-site environmental monitoring. A separate, related patent addresses ex-ante credit issuance protocols based on predictive modeling, digital twin simulations, and forward-looking ecological forecasts.

### BACKGROUND OF THE INVENTION

Environmental credit systems-particularly carbon credit mechanisms—have become widely used instruments for incentivizing conservation and sustainable resource management. However, the existing market is disproportionately focused on carbon credits, driven by more mature legal frameworks and verification protocols. Other ecological value streams—including biodiversity preservation, water management, and multi-credit ecological accounting—remain underdeveloped. This underutilization has limited the full monetization potential of many land parcels that could generate multiple forms of verified ecosystem service credits.

Conventional environmental credit generation methods, such as those used in REDD+ projects, typically rely on modeled forecasts based on historical baseline data and static satellite imagery. These projections introduce uncertainty, reduce verification accuracy, and contribute to declining trust in voluntary carbon markets. As a result, buyer confidence and market scalability have been significantly constrained. The present invention addresses these issues by transforming real-time ecological data into verified digital credits through an integrated system of sensors, AI protocols, and smart contract execution, ensuring continuous data-driven validation, transparency, and market integrity.

Existing market practices often rely on periodic field audits—annually or less—rather than offering real-time validation. This creates transparency gaps and exposes projects to risks such as over-crediting or unobserved ecosystem degradation. Furthermore, biodiversity and water credits lack standardized, integrated methodologies. Common approaches—such as eDNA testing or wildlife surveys—are executed independently from credit issuance platforms, increasing costs and reducing systemic trust. The present invention consolidates ecological input sources into a unified Ecological Oracle Engine, enabling the real-time issuance, monitoring, and pricing of credits across multiple categories.

For instance, Publication No. US 2025/0086967 relies on public databases and generalized remote sensing algorithms. While useful for trend detection, these systems lack parcel-level precision and do not ingest land-specific sensor data. In contrast, the present invention incorporates a hybrid architecture combining satellite data with field-level instruments—including drones, eDNA samplers, and IoT sensor networks—to achieve high-confidence, site-specific certification outcomes.

Similarly, U.S. Pat. No. 11,615,428 offers a method for estimating carbon credit potential based on spatial datasets, but is limited to static assessments. The present invention moves beyond estimation to fully autonomous issuance and lifecycle management, based on continuous ecological performance data from diverse sensor arrays across land and water assets.

Older patents like U.S. Pat. Nos. 5,808,916 and 10,387,589 B2 aggregate environmental data for forecasting but are not designed to create or manage credits. They lack real-time ingestion, tokenization, and smart contract integration. They do not function as autonomous, financial-grade certification tools. In contrast, the present invention is built from the ground up as a real-time financial instrument generator for environmental performance.

U.S. Application No. 2025/0102360 A1 enables 3D digital twins for environmental monitoring but lacks the mechanisms for credit issuance, smart contract execution, or DAO integration. It provides data visualization, but not autonomous ecological finance infrastructure.

U.S. 2014/164070 estimates monetary credit values based on user-defined scenarios, but does not generate, verify, or register credits in real time. It does not address smart contract governance or link data streams to blockchain-based financial products.

Likewise, U.S. Pat. Nos. 8,111,924 and 7,457,758 rely on retrospective modeling to estimate carbon stocks using field plots or soil measurements. They do not enable credit automation, price discovery, or dynamic credit freezing based on live data. The present invention closes this gap with a blockchain-driven certification engine powered by verified, real-time ecological signals.

KR20220066534 offers a satellite imagery-based carbon inventory solution, but cannot issue, price, or revoke credits based on ecological performance. The present system combines imaging, local telemetry, and AI-based analysis to enable autonomous environmental credit creation with continuous eligibility validation.

Recent blockchain-based credit platforms—such as those described in US20200111105A1, US20220101430A1, and EP4377921A1—enable tokenization but are based on traditionally certified credits. They do not include field-level validation, adaptive pricing, anomaly detection, or automatic enforcement logic. In contrast, the present invention integrates these mechanisms into a unified pipeline.

Therefore, the Real-Time Certification and Lifecycle Automation of Environmental Credits system described in this invention offers a novel, integrated approach. It replaces fragmented, manually verified workflows with automated credit certification based on live ecological data. It combines an AI-driven analysis engine, a dynamic rule-based certification layer, and smart contract infrastructure to manage issuance, pricing, validation, freezing, and retirement. The system is applicable across carbon, biodiversity, and water credits, delivering scalable, auditable, and transparent certification aligned with natural capital monetization needs.

### Objectives of the Invention

The objective of the present invention is to enable fast, scalable, cost-efficient, and transparent certification of Ex-Post environmental credits by introducing real-time issuance and verification workflows. The invention minimizes reliance on traditional manual audits and third-party verifications—which typically require retrospective documentation and human-led site inspections—by deploying a continuous, automated monitoring infrastructure. Using IoT sensors, remote sensing, and ecological data streams, the system replaces periodic assessments with ongoing measurement. Artificial intelligence algorithms autonomously analyze incoming ecological data, validate performance conditions, and determine eligibility for credit issuance. This ensures that environmental credits are issued based on actual, verifiable ecological outcomes rather than projections or forward-looking estimates. The approach significantly enhances accuracy, transparency, and stakeholder confidence in environmental markets.

A further objective of the invention is to implement a fully autonomous lifecycle management protocol for environmental credits. Through smart contracts deployed on a blockchain infrastructure, the system governs key lifecycle events—including issuance, pricing, transfer, bundling, freezing, and retirement—without requiring manual intervention. Each lifecycle event is transparently recorded on-chain, ensuring immutability, auditability, and protection against manipulation or clerical error. Smart contracts are programmed with rules that enforce ecological performance thresholds, allowing credits to be automatically reclassified, frozen, or revoked in response to real-time field conditions and validation results.

A third objective is to enable diversified and sustainable revenue generation from a single land parcel or conservation unit by supporting simultaneous issuance of multiple verified credit types—including but not limited to carbon, biodiversity, and water credits—or bundled instruments thereof. This multi-credit architecture is grounded in real-time, independently verified ecological data and enables landowners, project developers, and indigenous communities to optimize natural capital utilization. By stacking credits from parallel ecological services without double-counting, the system creates a more resilient and financially productive model for environmental stewardship.

### BRIEF SUMMARY OF THE INVENTION

In accordance with the objectives stated above, the present invention discloses a fully integrated, real-time system for the autonomous certification and lifecycle automation of environmental credits—specifically limited to Ex-Post issuance protocols. Unlike prior art that tokenizes manually verified credits issued through external registries (e.g., Verra, Gold Standard), this invention covers the entire credit lifecycle—from raw data acquisition through validation, issuance, transfer, and retirement—under a single, automated digital infrastructure.

The system begins with continuous ecological monitoring through a diverse data acquisition layer (Module 101), which includes IoT-based environmental sensors (201, 202, 203), drones (204), satellite imagery (211), environmental DNA (eDNA) samplers (206), and structured community observations (209). These are supplemented with historical datasets and third-party satellite records (211) for baseline calibration and comparative analysis.

All incoming data streams pass through a dedicated Data Validation and Ingestion Module (Module 102), which filters, formats, and prepares the data for machine analysis. A Reference Library Module (302) maintains continuously updated databases of ecological indicators, species references (302-1), acoustic patterns (302-2), and genomic markers (302-3). A Feedback Learning Loop (303) integrates validated outputs and ground-truth corrections to improve AI performance over time.

Validated data enters the AI Verification and Analysis Protocol (Module 103), which performs real-time ecological scoring (403), pattern recognition, species detection (402), and anomaly flagging (405). These outputs are routed to a Certification Engine (Module 104), where measurable ecological impact—such as carbon sequestration or biodiversity presence—is quantified, and eligibility thresholds for credit issuance are assessed.

Once ecological conditions are verified, the system autonomously generates digital environmental credits, which are transferred to a Smart Contract Execution Module (Module 105). These smart contracts issue tokenized credits on a blockchain, each registered under a unique serial number and bound by programmable lifecycle rules governing transferability, pricing, bundling, expiration, or retirement.

The blockchain layer is not used solely for record-keeping or post-verification tokenization but functions as a core execution environment within the real-time issuance workflow. All credit issuance, update, or freezing actions are initiated by ecological data and enforced through immutable smart contract logic.

A Credit Tracking and Retirement Module (Module 106) monitors credit ownership, use, and eventual decommissioning. Credits may be retired based on user action, ecological non-compliance, or system-defined thresholds. Lifecycle events are logged transparently on-chain, ensuring traceability, accountability, and prevention of double issuance or misuse.

Credits may be transacted through authorized brokers, decentralized exchanges, or bundled into composite instruments representing multiple ecosystem services. All modules are designed to operate as an integrated pipeline for Ex-Post credit issuance, requiring minimal manual input and ensuring scientific verifiability at every step.

Optionally, the invention may interoperate with a Digital Twin of Nature (Module 107), which enables real-time ecological modeling, forecasting, and 3D simulation of ecosystem behavior. These features, described in a separate patent, enhance decision-making, stakeholder engagement, and AI training but are not required for credit issuance under this invention.

The invention may also integrate with Web3 infrastructure (Module 108), including DAO-based governance and programmable ReFi instruments. Environmental data validated by the Ecological Oracle Engine powers decentralized marketplaces and risk management frameworks, ensuring that every digital asset linked to ecological performance is traceable to verified, on-chain ecological signals.

### BRIEF DESCRIPTION OF THE DRAWINGS

FIG. 1 Is a schematic diagram illustrating the ecological oracle system architecture, including environmental data sources, a data ingestion layer, a reference library creation module, an AI-powered verification engine, a digital twin generation module, a blockchain integration layer, a smart contract execution module and credit tracking and retirement module.

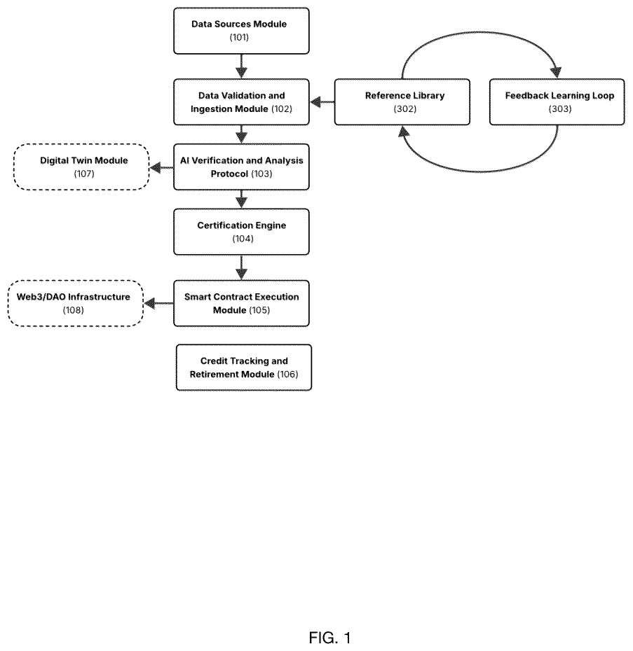

FIG. 2 Illustrates the structure of the Data Sources Module, showing the various categories of environmental data collected by the system.

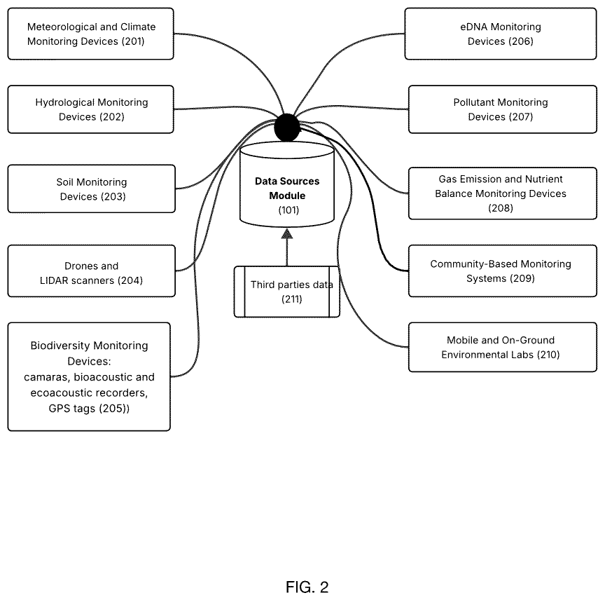

FIG. 3 Illustrates the structure of the Data Validation and Pre-Processing Module, which is responsible for ensuring the integrity, consistency, standardization, and readiness of the environmental data collected by the system. The structure of the Reference Library Creation Module, which is responsible for building and maintaining curated datasets essential for system operations. And the structure of the Feedback Learning Loop Module, which enables continuous improvement of system performance by integrating error signals, model evaluation metrics, and ground-truth data.

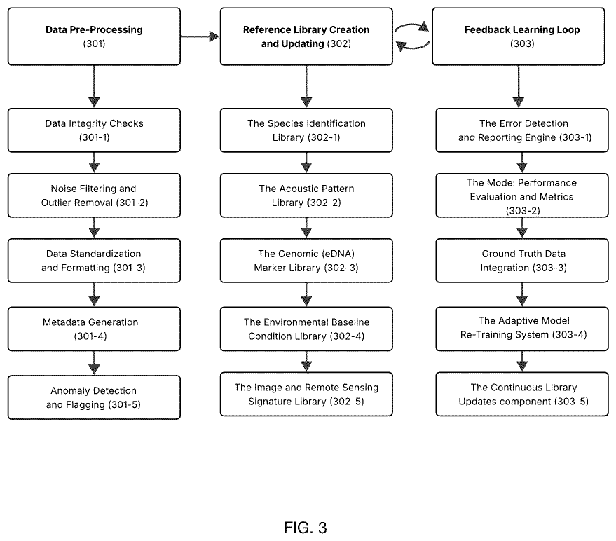

FIG. 4 illustrates the structure of the AI Verification and Analysis Protocol, which processes validated environmental data to certify environmental credits, update dynamic digital twin models, detect ecological anomalies, and manage adaptive risk thresholds.

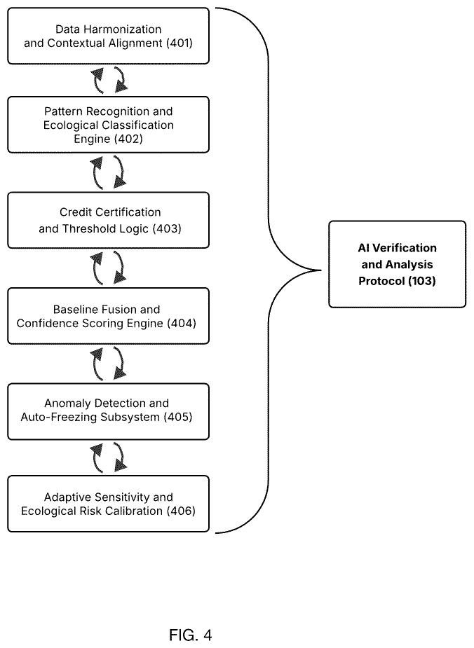

FIG. 5 Illustrates the Certification engine with smart contract execution logic, Freeze/Burn handler and compliance lawyer.

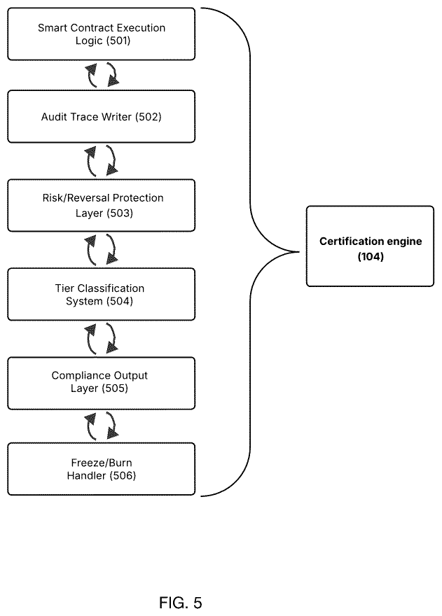

### DETAILED DESCRIPTION OF THE INVENTION

In accordance with the previously stated objectives and as illustrated in the accompanying figures, the present invention discloses a fully integrated, real-time system for the certification and lifecycle automation of environmental credits. The system comprises a set of interconnected technical modules, including but not limited to: the Environmental Data Sources Module (101), the Data Validation and Ingestion Module (102), the AI Verification and Analysis Protocol (103), the Certification Engine (104), the Smart Contract Execution Module (105), and the Credit Tracking and Retirement Module (106). These modules enable the autonomous issuance, verification, pricing, freezing, transfer, and retirement of tokenized environmental credits on a blockchain network, with minimal human intervention. Optional integration layers include the Digital Twin Module (107) and Web3/DAO Infrastructure (108), which support simulation-based planning and decentralized governance, respectively. These optional modules are referenced for interoperability only and are not part of the inventive scope of the present Ex-Post protocol.

The system architecture is grounded in real-time, sensor-collected ecological data specific to the land parcel or aquatic ecosystem under management. Data acquisition devices—described in Module 101—transmit field data via edge-to-cloud networks to a central server. Unlike traditional systems that depend on manually created baselines, static imagery, or post-hoc consultant reports, this invention performs Ex-Post credit certification using live environmental measurements that directly reflect ecosystem outcomes. Although satellite imagery and public or private third-party data sources (211) may be optionally integrated for historical benchmarking, credit issuance and validation are strictly based on on-site data acquisition.

The modular pipeline functions as follows: raw ecological data is acquired in Module 101, validated and harmonized in Module 102, semantically analyzed by AI engines in Module 103, quantified and certified in Module 104, and issued as programmable digital credits via blockchain smart contracts in Module 105. The lifecycle of each credit—tracking, freezing, bundling, transfer, and retirement—is autonomously managed via governance logic embedded within the Credit Tracking and Retirement Module (106). This integrated architecture replaces manual MRV practices with transparent, auditable, and real-time performance verification mechanisms.

The system is intended for use in a variety of Ex-Post credit-generating applications, including but not limited to: REDD+ (avoided deforestation), reforestation, biodiversity habitat protection, water conservation, and soil or nutrient recovery programs. While the invention may interoperate with simulation-based tools such as the Digital Twin Module (107) for planning or modeling purposes, such modules are the subject of separate Ex-Ante credit issuance patents and are not claimed herein. The invention disclosed in this application exclusively addresses the Ex-Post pathway: the autonomous issuance and lifecycle management of environmental credits based on verified ecological outcomes. Table 1 (not shown) provides an overview of the system's core modules, which may be updated or extended to support additional credit classes and regulatory frameworks as the natural capital market evolves.

### Environmental Data Sources Module

The Environmental Data Sources Module (Module 101) forms the empirical foundation of the autonomous environmental credit certification system. It enables real-time issuance, ongoing validation, and blockchain-enforced lifecycle governance of environmental credits by continuously collecting high-resolution ecological data from sensor-equipped land parcels or aquatic ecosystems. Unlike conventional MRV systems that rely on periodic human audits, modeling, or generalized remote imagery, this module deploys a site-specific monitoring infrastructure that transmits data directly to a secure server, triggering downstream credit certification and smart contract automation.

Submodules 201 through 204 cover physical and ecological parameters, including: Meteorological Devices (201): Measuring site-level air and soil temperature, humidity, wind, and precipitation using AWS units and portable weather kits; Hydrological Devices (202): Monitoring flow rates, dissolved oxygen, pH, and water levels from rivers, wetlands, and streams; Soil Monitoring Devices (203): Measuring moisture, carbon, erosion indicators, and macro-nutrient fluxes; Forest and Landscape Monitoring Devices (204): Using drone-mounted LiDAR, orthophotography, and satellite feeds for vegetation structure and biomass estimation.

Submodules 205 through 208 address biological and chemical integrity: Biodiversity Devices (205): Including camera traps, bioacoustic sensors, and GPS-tagged animal trackers for species identification and behavioral data; eDNA Devices (206): Autonomous units for real-time aquatic or terrestrial DNA sampling and preliminary sequencing; Pollutant Detection Devices (207): Sensing hydrocarbons, heavy metals, microplastics, and other contaminants; GHG and Nutrient Flux Devices (208): Measuring real-time CO₂, CH₄, N₂O, nitrogen, and phosphorus dynamics, directly linked to carbon and soil credit logic.

These components operate as a synchronized verification network. Data streams are continuously recorded, and anomalies or compliance thresholds directly affect downstream modules. Unlike prior systems where data is analyzed manually post hoc, this module feeds validated inputs into smart contracts that autonomously issue, freeze, or retire credits based on real-time ecological performance.

Additional data sources include: Community-Based Monitoring Systems (209): Local users contribute geo-tagged observations via standardized mobile apps, providing crowdsourced biodiversity and disturbance data; Mobile and On-Ground Labs (210): Field laboratories enable same-day verification of anomalies, eDNA validation, and sample processing; Third-Party Data Providers (211): Satellite imagery and ecological records (e.g., NASA, ESA) are used for regional comparison and historical modeling only. They do not trigger credit issuance and are explicitly excluded from the certification pipeline.

All field hardware operates independently via solar power and is designed for off-grid deployment. Network connectivity is enabled via mesh protocols, LoRaWAN, or satellite uplinks such as Starlink. All collected data is timestamped, encrypted, and geotagged, ensuring full traceability, auditability, and compliance with environmental data security standards.

Scope Clarification: The present invention does not claim novelty in the individual environmental monitoring devices described above, as these components are established in existing scientific and technical literature. Instead, the novelty lies in their integrated deployment, synchronized data acquisition, and their automated interaction with AI analysis, certification logic, and blockchain-based smart contract systems. Unlike legacy MRV systems, which treat environmental monitoring as a passive exercise, Module 101 constitutes an active control layer whose verified outputs dynamically govern real-time issuance, freezing, pricing, and retirement of environmental credits. This integration transforms ecological performance into tradable digital instruments without human auditors or third-party validation, thereby enabling a fully autonomous ecological finance infrastructure.

### Data Validation and Ingestion Module

The Data Validation and Ingestion Module (102) enables the transformation of raw, heterogeneous ecological inputs into structured, auditable data streams capable of triggering real-time environmental credit issuance, smart contract actions, and DAO-based governance. While the individual techniques—such as noise filtering or standardization—may be established in the art, the novelty lies in their orchestrated configuration and dedicated role in powering a fully autonomous environmental credit infrastructure based on live ecological measurements.

Scope Clarification: The present invention does not claim originality over generic signal processing algorithms, statistical filters, or standard metadata schemas in isolation. Instead, it claims the specialized application and architectural integration of these functions into a real-time data-to-credit pipeline, wherein sensor data flows directly into AI analysis, smart contract execution, and blockchain registries—without manual validation. This enables continuous, tamper-proof issuance, adjustment, or retirement of environmental credits in accordance with ecological performance, not prediction.

The Data Pre-Processing Submodule (301) comprises: Data Integrity Checks (301-1): Confirms packet completeness, timestamp validity, sensor ID authenticity, and spatial location within declared project boundaries. Noise Filtering and Outlier Removal (301-2): Applies context-aware filters to eliminate improbable or corrupted values while preserving ecological fidelity. Data Standardization and Formatting (301-3): Translates incoming data into interoperable formats compatible with downstream modules, external MRV standards, and blockchain storage. Metadata Generation (301-4): Attaches key attributes to each record (e.g., sensor version, environmental conditions, calibration status) for auditability and legal traceability. Anomaly Detection (301-5) and Flagging: Identifies abnormal patterns—such as ecological collapse signals or technical drift—and forwards flagged data for escalation, review, or automatic contract-triggered actions. All outputs are passed to the AI Verification and Analysis Protocol (103), where ecological classification, pattern recognition, and certification thresholds are applied.

The Reference Library Creation and Updating Submodule (302) provides the structured ecological intelligence required for automated classification, species detection, and environmental baselining: Species Identification Library (302-1): Verified taxonomies and ecological characteristics for flora and fauna, georeferenced and sensor-linked. Acoustic Pattern Library (302-2): Time-stamped and labeled audio profiles for species, soundscapes, and disturbance events. Genomic (eDNA) Marker Library (302-3): Barcodes, allele frequency references, and population-level markers for real-time species validation. Environmental Baseline Condition Library (302-4): Ecosystem-specific ranges for soil, hydrology, and climate variables, built from historical and dynamic data. Image and Remote Sensing Signature Library (302-5): AI-labeled imagery and spectral profiles for detecting land cover, biomass, and disturbance. All libraries are modular, version-controlled, and automatically enriched using outputs from the Feedback Learning Loop (303) and verified field updates.

The Data Validation and Ingestion Module (102) is not merely a preprocessing step; it is the scientific and legal backbone of the invention. Without this layer, raw data would lack credibility, traceability, and standardization—rendering autonomous issuance infeasible. Through its structured outputs, this module ensures that downstream AI classifications (103), certification thresholds (104), and smart contract decisions (105) operate on verified, interoperable, and defensible data. This replaces manual MRV systems with an auditable, real-time, logic-enforced alternative that scales across geographies, ecosystems, and regulatory environments.

### AI Verification and Analysis Protocol

The AI Verification and Analysis Protocol (103) is a core technical component of the present invention, architected to enable real-time, outcome-based issuance of environmental credits (ex-post). It receives validated ecological data from the Data Validation and Ingestion Module (102), which includes sensor-derived measurements of carbon flux, biodiversity presence, water quality, and pollutant concentrations originating from field-deployed infrastructure (Module 101). This module governs the analytical decision layer that determines whether credits are to be issued, updated, frozen, or retired—without human intervention.

This invention does not claim novelty in individual artificial intelligence components (e.g., CNNs, segmentation models), but rather in their coordinated deployment within a system that connects verified field data to smart contracts, blockchain registries, DAO governance, and autonomous lifecycle enforcement. All inferences made by this module are logged with associated confidence scores and metadata, ensuring traceability and regulatory defensibility. The protocol includes the following submodules:

Data Harmonization and Contextual Alignment (401). Synchronizes heterogeneous data streams (LIDAR, satellite, acoustic, IoT, eDNA) into a unified spatiotemporal grid. This ensures temporal coherence and spatial compatibility across ecological indicators, supporting downstream classification and credit logic. It aligns data to parcel boundaries and project geofences to preserve scope fidelity.

Pattern Recognition and Ecological Classification Engine (402). Powered by CNNs, LSTM models, and U-Net segmentation, this engine extracts ecological features from time-series and image inputs. Tasks include: Biomass growth and canopy density mapping from NDVI and SAR imagery; Detection of habitat fragmentation, land cover change, and forest loss; Identification of species via acoustic signatures, camera traps, or GPS tags; Validation of biodiversity or water quality indicators against baseline thresholds. This engine enables fully automated classification of land plots as credit-eligible or non-compliant, based solely on field-measured outcomes.

Credit Certification and Threshold Logic (Ex-Post Only) (403). This module applies predefined performance thresholds (e.g., net carbon sequestration ≥15 tCO₂/ha over 3 months) and ecosystem-specific rules to determine credit issuance eligibility. Certification occurs only when ground-verified indicators meet or exceed validated standards. Example outputs include: “Plot X sequestered 17.2 tCO₂ between January-March 2025. Confidence: 96%. Status: VALID FOR ISSUANCE”. Unlike static estimations used in traditional MRV, this logic is dynamically triggered by live performance data, ensuring precision and preventing over-crediting.

Bayesian Fusion and Confidence Scoring Engine (404). This subcomponent integrates uncertainty quantification, combining multiple AI outputs using Bayesian inference. It generates a confidence score (e.g., 96%) and flags cases of model conflict or insufficient data. This score is embedded into the credit metadata and may influence pricing or eligibility in downstream DAO or market platforms.

Example: Real-Time Confidence Scoring via Bayesian Fusion Engine in Ex-Post Carbon Credit Issuance. A representative implementation of the Bayesian Fusion and Confidence Scoring Engine is illustrated by the following scenario. A conservation project located within the Peruvian Amazon is subject to ex-post evaluation for carbon credit issuance. The evaluation period spans three consecutive months (January to March 2025) and focuses on the quantification of forest regeneration and associated carbon dioxide (CO₂) sequestration. During the assessment window, the system receives multi-modal ecological data inputs comprising: Drone-derived LiDAR biomass scans; Satellite-based NDVI (Normalized Difference Vegetation Index) time-series imagery; Soil-respiration sensors measuring CO₂ fluxes; Environmental DNA (eDNA) samples indicating regrowth of understory species. Each input data stream exhibits limitations, such as signal noise, data resolution variance, or temporal gaps resulting from cloud interference and sensor latency. When assessed individually, no single input meets the minimum system confidence threshold for credit eligibility as defined by certification protocol logic (see Module 104). The Bayesian Fusion Engine, in response, executes the following operations: Step 1—Prior Confidence Modeling: The system references prior probability distributions derived from a two-year corpus of validated ground-truth biomass data obtained from analogous Amazonian parcels. These priors establish a baseline expectation for each input's reliability and ecological significance. Step 2—Weighted Multi-Modal Integration: The engine applies Bayesian statistical inference to integrate the heterogeneous data streams as follows: Satellite NDVI: assigned a prior confidence weighting of 80%; Drone LiDAR biomass: assigned a high-confidence weight of 93%; Soil gas flux measurements: weighted at 85% confidence, adjusted for 15% data incompleteness; eDNA biodiversity signals: assigned a low-confidence weighting of 65% due to limited taxonomic resolution and partial read coverage. Step 3—Output Generation and Scoring: Following uncertainty propagation and probabilistic synthesis, the engine generates the following results: Final Composite Confidence Score: 91.4%; Credit Eligibility Status: VALID; Estimated Sequestration Value: 14.3 metric tons CO₂ (January-March 2025); Ecological Risk Classification: LOW (No anomalies detected). The downstream Certification Engine (Module 104) receives the scoring output and proceeds with autonomous credit issuance via the Smart Contract Execution Module (105). All input data, fusion logic, and confidence assumptions are immutably logged to the blockchain registry for auditability. The system's minimum confidence threshold for ex-post issuance (≥90%) is satisfied, thus enabling tokenized credit creation with verified ecological substantiation.

Anomaly Detection and Auto-Freezing Subsystem (405). This layer continuously monitors post-issuance performance. Using drift detection, anomaly modeling, and outlier analysis, it identifies signs of degradation (e.g., NDVI drop, species disappearance, GHG reversal). If triggered, it sends a signed signal to the Smart Contract Execution Module (105) to freeze the credit and block trading until resolution.

Example: Autonomous Anomaly Detection and Smart Contract-Based Freezing of Environmental Credits. In one embodiment of the invention, the Anomaly Detection and Auto-Freezing Subsystem (405) is applied in a REDD+ project situated within the Amazon basin. The project area, managed by an enrolled landowner, has previously undergone successful credit certification via the AI Verification and Analysis Engine (103), resulting in the issuance of 20,000 ex-post carbon credits corresponding to verified avoided deforestation. Said credits were tokenized and recorded immutably on a blockchain registry through the Smart Contract Execution Module (105). Following issuance, a real-time ecological monitoring regime remains active for the credited parcel. Data streams collected during the three-month post-certification period include: Light Detection and Ranging (LiDAR) scans for biomass and canopy analysis; Satellite-based NDVI time-series imagery; IoT-enabled forest canopy sensors; Bioacoustic recorders and camera traps capturing species presence. A trigger event is detected whereby the AI Verification Protocol (103) registers an abrupt and statistically significant NDVI drop of approximately 35% across a contiguous 12-hectare zone within the credited area. This decline exceeds the predefined ecological degradation threshold of 25% established by the Certification Engine (104) for the relevant ecosystem type. The verification cascade proceeds as follows: The Bayesian Fusion and Confidence Scoring Engine (404) confirms, with a calculated confidence level of 94%, that the observed NDVI drop is anomalous and not attributable to seasonal variation, based on comparison with regional temporal models and prior historical baselines; The Anomaly Detection Module (405) further corroborates the event by cross-referencing an absence of acoustic signatures from multiple bird species previously tagged and identified in the affected zone; Concurrent satellite thermal imaging reveals heat anomalies suggestive of illegal anthropogenic disturbance (e.g., burning or unpermitted logging). Based on the above multi-modal confirmation of ecological disturbance, the Anomaly Detection and Auto-Freezing Subsystem autonomously issues a smart contract instruction to freeze the corresponding environmental credits. The following outcomes are executed: A total of 3,250 credits, associated with the impacted 12 hectares, are immediately suspended; The status of the affected credits is updated to “Under Review-Ecological Integrity Breach Detected” within the blockchain registry; Automated notifications are dispatched to the project's DAO (if enabled) and designated certifying authority, inviting optional human oversight or remedial investigation; All ecological signals, fusion model outputs, and system-triggered actions are cryptographically timestamped and embedded as immutable metadata within the credit records. As a result, trading, transfer, or bundling of the suspended credits is halted pending revalidation. This mechanism serves to maintain the environmental integrity of the registry, prevent the circulation of compromised credits, and safeguard stakeholder trust in the system's real-time ecological enforcement capacity.

Adaptive Sensitivity and Ecological Risk Calibration (406). This logic recalibrates thresholds based on ecosystem-specific baselines and seasonal norms. For example, it adjusts canopy-loss alerts in deciduous forests during dry seasons. These adaptive models help prevent false positives and ensure region-specific, time-aware decision making.

### Certification Engine

The Certification Engine (104) operates as the legally accountable, blockchain-integrated enforcement layer within the present invention. It converts the outputs of the AI Verification and Analysis Protocol (103) into binding, machine-executed certification events. These include credit issuance, tier classification, freezing, or revocation, executed autonomously based on validated ecological performance data.

The Certification Engine is designed for autonomous operation within the ex-post issuance framework as defined in this application. Although compatible with predictive ex-ante systems (e.g., digital twin simulations described in separate patent applications), the present invention is limited to real-time, outcome-based certification.

While subcomponents such as smart contracts, tier logic, and audit logs may exist across isolated platforms, the inventive step of this system lies in the integrated application of these mechanisms to create a unified, fully automated ecological certification infrastructure. Specifically, the Certification Engine enforces credit actions programmatically tied to live, AI-derived ecological metrics, eliminating the need for human validation, batch processing, or reliance on external methodologies. This integration replaces manual monitoring, reporting, and verification (MRV) with a continuous, algorithmically governed system for credit issuance and lifecycle management.

### Key Subcomponents and Functionalities:

Smart Contract Execution Logic (501). Receives verified outputs from the AI Verification and Analysis Protocol and executes blockchain actions such as credit minting, updating, or retirement. Each credit is assigned a unique serial ID and project metadata, ensuring traceability, immutability, and regulatory compliance. This logic operates without manual intervention or reliance on third-party certification bodies.

Audit Trace Writer (502). Logs certification metadata including input hashes, model versions, issuance timestamps, GPS coordinates, and applied threshold logic. These records are stored in tamper-proof formats accessible to authorized registries, DAO platforms, or independent auditors.

Risk and Reversal Protection Layer (503). Applies automated safeguards including: Smart contract-based buffer pools (e.g., 10% reserve), Conditional time-locks (e.g., 30-day post-certification holding), Clawback mechanisms in the event of ecological degradation. All protections are automatically triggered by ecological signals verified in real time.

Illustrative Use Case—Risk and Reversal Protection (503): A tropical forest parcel in the Amazon basin issues 50 tCO₂e credits. The Certification Engine reserves 5 credits in escrow. If NDVI and carbon flux remain stable for 12 months, the buffer credits are released. If degradation is detected (e.g., canopy loss, carbon reversal), the credits are burned or revoked.

Tier Classification Subsystem (504). Credits are programmatically categorized as: Tier 1 (Verified): Real-time, field-measured issuance (covered in this patent). Tier 2 (Predictive): Modeled issuance via simulation (excluded from this patent but part of the broader protocol framework).

Compliance Output Generator (505). Generates certification documents formatted for ISO 14064 and jurisdictional compliance. Outputs include baseline datasets, impact quantification, and monitoring records for optional upload to external registries.

Freeze/Burn Handler (506). Monitors post-issuance ecological performance. Upon detecting environmental noncompliance (e.g., NDVI decline, species loss), this handler: Flags affected credits, Freezes tradability, Burns credits if conditions persist, Notifies registries or DAO layers.

Illustrative Use Case-Freeze/Burn Handler (506): In a coastal mangrove restoration project, credits are issued and stored on-chain. A significant NDVI decline and absence of key acoustic indicators trigger an automated freeze. If conditions fail to recover within 30 days, affected credits are permanently burned, with full metadata stored on-chain.

Upon successful certification, the smart contract mints or updates the environmental credit, assigns a unique serial identifier, and logs all relevant metadata immutably on a blockchain registry. Lifecycle changes, tier reclassifications, and DAO governance actions are also executed and recorded in a tamper-proof format, eliminating the need for manual intervention or third-party synchronization.

### Smart Contract Execution Module

The Smart Contract Execution Module (105) constitutes the programmable automation layer of the present system. It is configured to perform all credit-related lifecycle operations-including issuance, transfer control, tier reclassification, and retirement-exclusively on the basis of certification outcomes generated by the AI Verification and Analysis Engine (103). In contrast to the Certification Engine (104), which determines credit eligibility, quantity, and ecological justification, Module 105 is responsible for the autonomous, enforceable execution of certified actions via blockchain smart contracts, without the need for manual processing or intervention by third-party registry administrators.

The module comprises a suite of parameterized smart contracts deployed on a permissioned or public blockchain infrastructure. Upon receiving a validated certification trigger, the corresponding contract automatically: Mints a tokenized environmental credit containing a unique serial identifier and cryptographically hashed metadata (e.g., project ID, issuance timestamp, geolocation, ecological metric values), Logs the credit issuance immutably on-chain, with timestamp and reference to the originating certification event, Initializes governance constraints including transfer permissions, freeze conditions, retirement triggers, and DAO oversight parameters.

Beyond issuance, the Smart Contract Execution Module is continuously synchronized with downstream system events and governance signals, including: Status updates from the Anomaly Detection Subsystem (405), Buffer and clawback instructions from the Risk and Reversal Protection Layer (503), Governance outcomes and performance-based resolutions from decentralized autonomous organization (DAO) layers.

The core programmable functions of Module 105 include: Freeze Instructions: Autonomous suspension of credit transferability in response to verified ecological nonperformance or metric deviation; Burn Logic: Irreversible revocation and deletion of noncompliant, fraudulent, or expired credits; Transfer Triggers: Conditional transfer execution based on DAO voting, compliance status, or risk-adjusted criteria; Tier Reclassification: Dynamic upgrade or downgrade of credit tier (e.g., from Tier 1 Verified to Tier 2 Pending) based on ecological monitoring and AI-derived performance assessments.

A distinguishing feature of this module is its ability to autonomously execute legally significant credit events—such as issuance, freezing, and retirement—without intermediated validation. In contrast to conventional registry systems, where administrators are required to validate credit status and update records manually, the present invention embeds governance and compliance logic directly into executable smart contracts. This configuration eliminates bottlenecks, reduces latency, and minimizes opportunities for manipulation or human error.

The module also incorporates programmable economic logic, including: Payout Instructions: Smart contract-based disbursement of proceeds (e.g., to a conservation fund or verified land steward) upon verified retirement of credits; Dynamic Pricing Logic: Real-time calculation of credit valuation based on ecological performance scores delivered by the Certification Engine (Module 501), ensuring market-linked transparency and auditability.

It is expressly noted that the use of smart contracts in isolation is not claimed as novel. However, the application of such contracts within the present system—as a fully integrated, real-time execution mechanism directly governed by continuously verified ecological data—constitutes a non-obvious and inventive configuration. Specifically, the ecological-to-contractual coupling enables trustless environmental credit governance at scale, with zero manual oversight and cryptographically enforced auditability across the entire credit lifecycle.

### Credit Tracking and Retirement Module

The Credit Tracking and Retirement Module (106) is configured to perform post-issuance lifecycle management of environmental credits generated through the system. This module provides auditability, ownership transparency, and finalization operations for tokenized environmental credits, without initiating certification or smart contract issuance actions. Unlike the Certification Engine (104) and Smart Contract Execution Module (105), which are responsible for ecological eligibility and on-chain issuance respectively, Module 106 ensures traceability, compliance history, and retirement status across the lifecycle of each issued credit.

Upon issuance and blockchain registration, each credit is assigned a unique identifier and metadata record. Module 106 continuously monitors credit status by logging transactional events including credit transfers, bundling into multi-utility products, fractionalization, staking, resale, or deposit into liquidity instruments such as vault contracts. Each action is linked to the originating credit ID and associated with its ecological performance history, certification metadata, and applicable DAO permissions.

A dedicated subcomponent of this module is a retirement ledger, which serves as a tamper-proof sub-registry. Credits are marked as permanently retired once they fulfill their intended function (e.g., emissions offset, compliance reporting, or conservation donation). Retirement may be triggered by stakeholder action, DAO governance resolution, or smart contract condition. All retirement events are appended to the credit's immutable audit trail, and retired credits are thereafter excluded from all forms of reactivation, resale, or recirculation.

In the event of smart contract-triggered freezes, revocations, or downgrades, Module 106 updates the credit status registry accordingly. Although the physical freeze or burn is executed via Module 105, this module is responsible for synchronizing status flags, archiving associated compliance records, and reflecting the updated status (e.g., Inactive, Suspended, or Revoked) across connected registries and credit views.

The module further supports interoperability with external systems via secure API connectors and blockchain bridges, enabling read-only access to lifecycle records by external ESG reporting platforms, national registries, or voluntary carbon market exchanges. These connections are cryptographically secured and do not alter internal registry content, thereby ensuring regulatory integrity and compliance-grade transparency.

An additional subcomponent, the Credit Provenance and Attribution Engine, provides authorized stakeholders with complete visibility over the lifecycle of a credit—from ecological event triggering, through AI verification and certification, to transfer history and final retirement. This transparency layer supports anti-fraud protocols, investor assurance, and enhanced traceability of ecological outcomes across voluntary and compliance markets.

While legacy carbon credit registries offer basic retirement tracking, the novel aspect of Module 106 lies in its autonomous, fully integrated architecture. It combines upstream ecological data lineage, AI-based certification, and blockchain-encoded lifecycle records into a unified, administrator-free infrastructure. This configuration enables real-time credit traceability and immutable auditability without requiring third-party oversight or batch-based manual validation processes.

1. A system for automated certification and autonomous lifecycle management of ex-post environmental credits, comprising:
a data acquisition subsystem configured to collect ecological data from a monitored ecosystem, the subsystem comprising:
(i) one or more ecological monitoring devices, including physical, chemical, biological, and remote sensing instruments selected from terrestrial, aquatic, aerial, or remote sensors, including bioacoustic monitors, hydrological sensors, meteorological instruments, soil sensors, environmental DNA (eDNA) samplers, image recognition cameras, drone-based LiDAR, satellite imagery feeds, or equivalent environmental input systems; and
(ii) a mobile interface or software application configured to receive structured, geo-tagged ecological observations from field personnel or community monitors;
a data ingestion and validation module, stored on a non-transitory computer-readable medium and executed by one or more processors, configured to filter, structure, and verify ecological data for accuracy, spatial coherence, and temporal consistency, and standardize the data for analysis and flag anomalies;
a verification engine comprising one or more machine learning models, rule-based classifiers, or statistical inference engines configured to classify ecological conditions and detect ecosystem service outcomes, generate confidence scores using multi-source data fusion, and identify anomalies and signal ecological performance deviations;
a certification module configured to evaluate ecological performance metrics against predefined issuance thresholds, determine issuance eligibility and assign credit tiers, and prohibit human delay or override once issuance criteria are met;
a lifecycle execution module comprising a smart contract engine defined as a self-executing program configured to issue digital environmental credits represented as tokens, digital assets, or equivalent electronic units, execute lifecycle events including issuance, freezing, repricing, bundling, tier classification, transfer, and retirement, and operate over distributed or centralized digital execution logic; and
a credit tracking and registration module configured to assign each credit a unique cryptographic or digital identifier, and record issuance and lifecycle metadata jointly or sequentially on a distributed ledger or equivalent registry system;
wherein the system autonomously governs the issuance and lifecycle of environmental credits based solely on validated ecological performance data, and said issuance and lifecycle actions are executed either in real time or at scheduled intervals, automatically and without requiring human intervention, discretion, or manual override once issuance criteria are met.

2. A method for automated ex-post certification and lifecycle governance of environmental credits, comprising:
collecting ecological data from a monitored land or aquatic parcel using one or more ecological monitoring technologies selected from IoT sensors, eDNA samplers, drones, satellite imagery, image recognition systems, bioacoustic devices, or equivalent ecological input systems;
validating the collected data using an ingestion module configured to confirm data integrity, remove anomalies, and standardize inputs for analysis;
analyzing the validated data through a verification engine comprising at least one of machine learning models, rule-based classifiers, or statistical inference algorithms configured to classify ecological outcomes and determine issuance confidence;
determining issuance eligibility using a certification logic module programmed with ecological performance thresholds and credit issuance rules;
automatically issuing one or more environmental credits in the form of digital tokens or equivalent electronic units upon satisfaction of issuance criteria;
executing lifecycle events including freezing, repricing, transfer, bundling, and retirement via a smart contract or equivalent automated logic system operating over centralized or decentralized infrastructure; and
registering each credit on a distributed ledger, registry system, or equivalent immutable record infrastructure;
wherein issuance and lifecycle actions are autonomously executed based on validated ecological data in real time or at scheduled intervals, without human intervention or override after eligibility is confirmed.

3. A system comprising:
(i) a data ingestion and validation engine configured to filter and standardize ecological data from sensors or field input;
(ii) a credit certification module configured to assess ecological performance and determine credit issuance eligibility based on programmable rules; or
(iii) a lifecycle management engine comprising a smart contract or equivalent program configured to issue, freeze, retire, or reclassify environmental credits in digital form;
wherein each module is operable independently or interoperably with other modules to enable autonomous environmental credit issuance or lifecycle governance, even in the absence of other components.

4. The system of claim 1, wherein smart contract execution is performed on a permissioned blockchain, public blockchain, or centralized cloud infrastructure supporting tamper-evident transaction records.

5. The system of claim 1, wherein no single ecological monitoring tool is required for certification, and any combination of equivalent data sources may be used to satisfy issuance logic.

6. The system of claim 1, wherein issuance timing is determined by programmable scheduling logic or smart contract conditions, and occurs in real time or at any deferred or periodic interval, without limitation to specific time cycles.

7. The system of claim 1, wherein the lifecycle management engine dynamically updates credit pricing or tier classification based on ecological performance indicators or external governance signals.

8. The system of claim 1, wherein lifecycle decisions are made by a decentralized autonomous organization via on-chain voting logic.

9. The system of claim 1, wherein the credit's digital representation includes immutable audit metadata comprising the originating sensor data type, geographic coordinates, issuance timestamp, model version, and confidence score.

10. The system of claim 1, wherein human operators are permitted to observe, monitor, or receive system outputs but are not permitted to override, delay, or intervene in issuance or lifecycle actions once certification criteria are satisfied.

11. The system of claim 1, wherein the issuance and registration of each credit are jointly or sequentially recorded on a distributed ledger or equivalent registry, regardless of execution layer.

12. The system of claim 1, wherein the smart contract engine comprises a self-executing program implemented on either a decentralized blockchain platform or a centralized infrastructure with automated execution logic.

13. The system of claim 1, wherein the digital environmental credits are represented as cryptographic tokens, digitally signed certificates, or equivalent electronic units tradable on regulated or decentralized marketplaces, including regulated registries, carbon exchanges, or decentralized finance protocols.

14. The system of claim 1, wherein the verification engine includes at least one of a rule-based logic model, a machine learning model, or a statistical classifier configured to determine issuance eligibility based on ecological performance data.

15. The system of claim 1, further comprising an audit layer that longs all data inputs, decision outputs, and lifecycle events for compliance and regulatory review.
